(19) United States
(12) Patent Application Publication
(10) Pub. No.: US 2026/0049464 A1
(43) Pub. Date: Feb. 19, 2026

(54) VALVE ASSEMBLY WITH AIR RELEASE AND SENSOR

(71) Applicant: Mueller International LLC, Atlanta, GA (US)

(72) Inventors: Daryl Lee Gibson, Chattanooga, TN (US); Mohammad Hassan Sobhani, Burlington (CA)

(21) Appl. No.: 18/804,548

(22) Filed: Aug. 14, 2024

(51) Int. Cl. E03B 9/04; F16K 37/00

(52) U.S. Cl. CPC E03B 9/04; F16K 37/005

(57) ABSTRACT

The present invention discloses a valve assembly comprising a seat ring, a valve plate assembly movable between a sealed position within the seat ring and an open position outside the seat ring. A fitting can pass through the valve plate, and/or a sensor assembly can extend through the fitting with a sensor mounted below the valve plate assembly. The sensor assembly provides enhanced monitoring capabilities by being positioned in the incompressible fluid column below the valve plate assembly, ensuring accurate sensing of relevant parameters. This configuration allows for efficient and reliable operation of the valve assembly, enhancing its performance and functionality in various applications.

### TECHNICAL FIELD

This disclosure relates to valve assemblies. More specifically, this disclosure relates to valves with subassemblies for air release and sensor applications.

### BACKGROUND

Previous approaches to valve assemblies, such as in hydrant shoes in dry barrel fire hydrants, have typically comprised a seat ring and a valve plate assembly that moves a valve between a sealed position against the seat ring and an open position spaced from the seat ring. These valve assemblies are commonly used in various industrial applications to control the flow of fluids, such as water or gas. The valve plate assembly is designed to create a seal when in the closed position to prevent leakage.

Sensors can be used to monitor various parameters within a system, such as pressure, temperature, presence of leakage, or flow rate within and/or proximate to the valve assembly. Generally, many types of sensors should be submerged in an incompressible fluid to enhance accuracy. When an air gap develops within the system, the air gap can interfere with the sensors and may affect the calibration, sensitivity, and/or accuracy of the sensor. For some sensors, air can act as a dampener that reduces the ability of the sensor to make accurate measurements.

### SUMMARY

It is to be understood that this summary is not an extensive overview of the disclosure. This summary is exemplary and not restrictive, and it is intended to neither identify key or critical elements of the disclosure nor delineate the scope thereof. The sole purpose of this summary is to explain and exemplify certain concepts of the disclosure as an introduction to the following complete and extensive detailed description.

In one aspect, disclosed is a valve assembly comprising: a seat ring; a valve plate assembly moveable between a sealed position wherein the valve plate assembly is sealed within the seat ring, and an open position wherein the valve plate assembly is moved out of the seat ring; a fitting extending through the valve plate assembly; and a sensor assembly extending through the fitting, a sensor of the sensor assembly mounted in the fitting below the valve plate assembly.

In a further aspect, disclosed is a valve assembly comprising: a seat ring; a valve plate assembly sealed within the seat ring in a sealed position, the valve plate assembly comprising a sealing disc and a lower valve plate; and an air release valve extends through the lower valve plate of the valve plate assembly.

In yet another aspect, disclosed is a method comprising: installing a fitting through a lower valve plate of a valve plate assembly and mounting a sensor in the fitting below the lower valve plate; installing an air release valve in the valve plate assembly; installing the valve plate assembly in a column of fluid defining a fluid surface level; and moving the air release valve from a closed position to an open position to remove air in the column of fluid and the sensor remains below the fluid surface level.

Various implementations described in the present disclosure may comprise additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations may be realized and obtained by means of the systems, methods, features particularly pointed out in the appended claims. These and other features will become more fully apparent from the following description and appended claims or may be learned by the practice of such exemplary implementations as set forth hereinafter.

### BRIEF DESCRIPTION OF THE DRAWINGS

The accompanying drawings, which are incorporated in and constitute a part of this specification, illustrate several aspects of the disclosure and, together with the description, serve to explain various principles of the disclosure. The drawings are not necessarily drawn to scale. Corresponding features and components throughout the figures may be designated by matching reference characters for the sake of consistency and clarity.

FIG. 1 is a perspective view of a fire hydrant assembly, in accordance with one aspect of the current disclosure.

FIG. 2 is a cross-sectional view of a portion of the lower barrel and the shoe in the fire hydrant assembly, taken along line 2-2 of FIG. 1.

FIG. 3 is a perspective view of a valve plate assembly and an air release assembly of the fire hydrant assembly in FIG. 1.

FIG. 4 is a top view of the valve plate assembly of FIG. 3 with an upper plate removed to show a stem assembly on an upper surface of a lower valve plate.

FIG. 5 is a side view of the valve plate assembly comprising the air release assembly in a closed position.

FIG. 6 is another side view of the valve plate assembly comprising the air release assembly of FIG. 5 in an open position.

FIG. 7 is a cross-sectional view of the valve plate assembly taken through the air release assembly in the closed position of FIG. 5.

FIG. 8 is a cross-sectional view of the valve plate assembly taken through the air release assembly in the open position of FIG. 6.

FIG. 9 is a detailed view of a closed seal shown in detail 9 of FIG. 7.

FIG. 10 is a detailed view of an open seal shown in detail 10 of FIG. 8.

FIG. 11 is a cross-sectional view taken along line 7-7 of FIG. 1, showing the valve plate assembly in the shoe of the hydrant assembly.

FIG. 12 is a cross-sectional view taken along line 2-2 of FIG. 1, showing the valve plate assembly in the shoe of the hydrant assembly.

### DETAILED DESCRIPTION

The present disclosure can be understood more readily by reference to the following detailed description, examples, drawings, and claims, and their previous and following description. However, before the present devices, systems, and/or methods are disclosed and described, it is to be understood that this disclosure is not limited to the specific devices, systems, and/or methods disclosed unless otherwise specified, as such can, of course, vary. It is also to be understood that the terminology used herein is for the purpose of describing particular aspects only and is not intended to be limiting.

In some valve assemblies, fittings may accommodate additional components such as sensors. Despite the advancements in valve assembly technology, there remains a need for improved sensor integration and positioning within the assembly to enhance monitoring capabilities and overall system efficiency. Existing designs may face challenges related to sensor accuracy, accessibility for maintenance, or interference with the valve operation. A valve assembly that optimizes the integration of sensors while maintaining reliable sealing and operational functionality would enhance the maintenance and/or remote operation of valve assemblies.

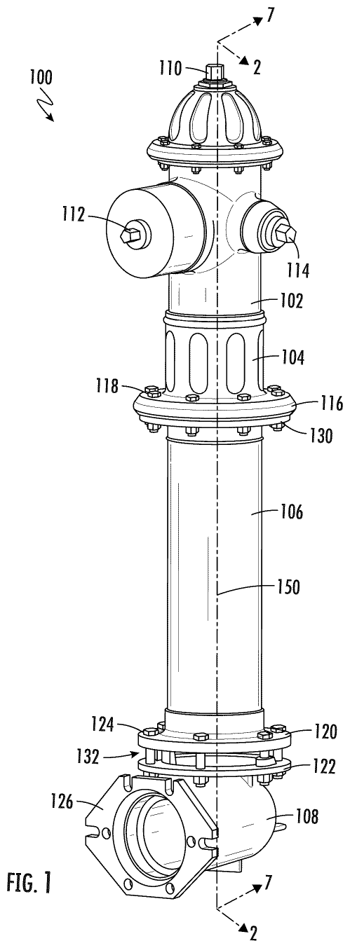

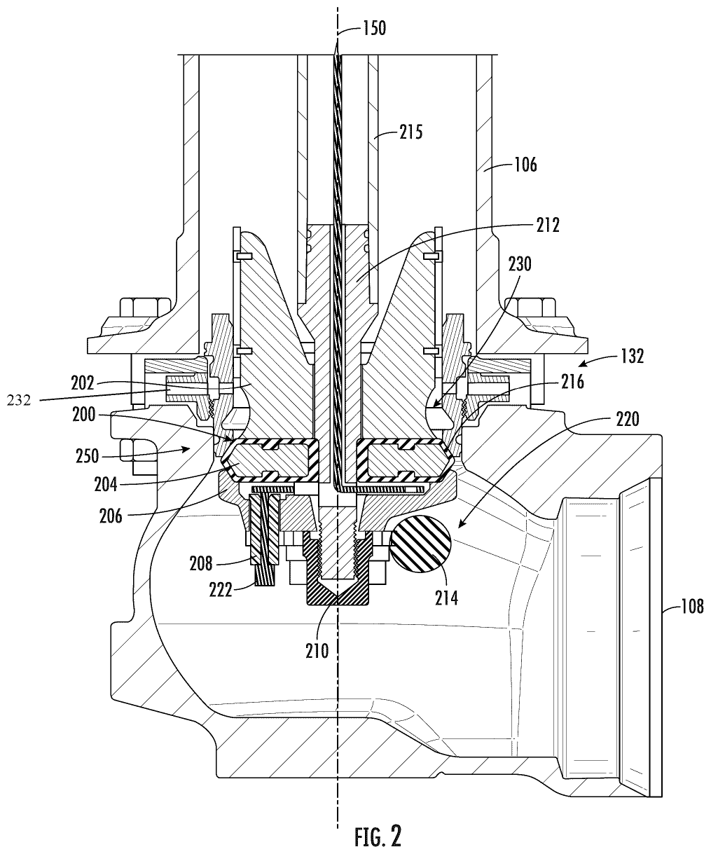

FIG. 1 is a perspective view of a hydrant assembly 100, e.g., a dry-barrel fire hydrant, in accordance with one aspect of the current disclosure. Hydrant assembly 100 can comprise water in the shoe and/or barrel, or hydrant assembly 100 can comprise a valve that separates the incompressible fluid (e.g., water) from the compressible fluid (e.g., air) in the shoe and/or barrel. A dry barrel fire hydrant is a hydrant that separates the incompressible fluid from the compressible fluid in the barrel and/or shoe. The hydrant assembly 100 can comprise a hydrant 102, an upper barrel portion 104, a lower barrel 106, and a hydrant shoe 108. An operating nut 110 can move a valve, such as valve plate assembly 200 (FIG. 2), in the shoe 108 by turning the nut 110, such as with a wrench, thereby filling the hydrant 102 of the hydrant assembly 100 with pressurized water. For example, operating nut 110 can facilitate maintaining lower barrel 106 and/or hydrant 102 dry when not in use, e.g., during freezing winter months, to protect hydrant assembly 100. Operating nut 110 can reduce required maintenance and/or facilitate the quick operation of hydrant 102, e.g., in an emergency response to a fire or for maintenance of the system. A central axis 150 extends centrally through the hydrant assembly 100 and forms a radial coordinate system for the components within the hydrant assembly 100.

The hydrant 102 can comprise a pump nozzle cap 112 and/or one or more hose nozzle caps 114, configured to couple to emergency equipment when the operating nut 110 charges the hydrant 102. In addition, bonnet flange 116 on the hydrant 102 and/or upper barrel can be coupled to a flange 130 on the lower barrel 106 with various bonnet flange fasteners 118 to join flanges 116, 130 to create a fluid-tight seal that delivers water from the lower barrel 106 to the hydrant 102. Similarly, the lower barrel 106 can extend from flange 130 to a lower barrel flange 120 that is coupled to a shoe flange 122 of the hydrant shoe 108 with one or more shoe fasteners 124. A space 132 can exist between the barrel flange 120 and shoe flange 122. A supply flange 126 can interconnect hydrant shoe 108 to a stub and/or directly to the utility, e.g., a water supply line. Other aspects of valve hydrant assemblies 100 are shown and described in U.S. Pat. Nos. 9,664,297 and 10,968,609, as well as U.S. Patent Publication No. 2023/0399826, each of which is incorporated herein by reference in its entirety.

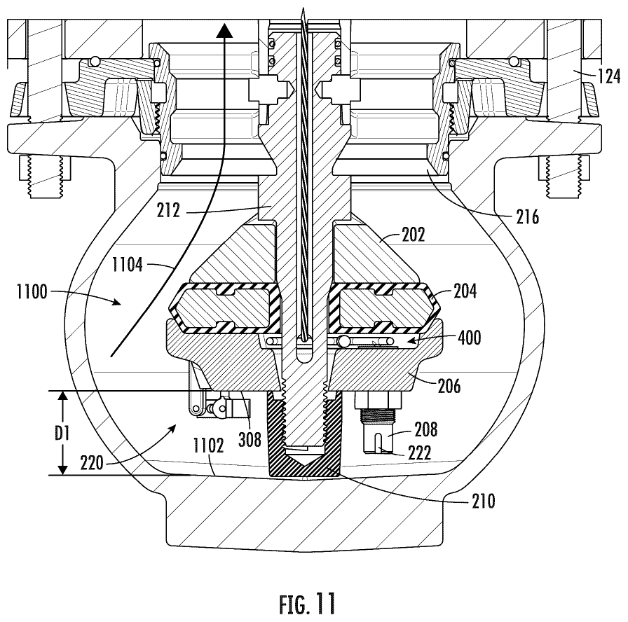

FIG. 2 is a cross-sectional view taken along line 2-2 of FIG. 1, showing a valve plate assembly 200 in a closed configuration 250 within a portion of lower barrel 106 and shoe 108 of the hydrant assembly 100. In some aspects, valve plate assembly 200 can fit between space 132 and provide one or more drain holes 232 that allow the lower barrel 106 to drain when the valve assembly 200 is moved to the closed configuration 250, and the valve plate assembly 200 can cover the drain holes 232 when the valve assembly 200 is moved to the open configuration 1100, shown in FIG. 11. Valve plate assembly 200 can comprise an upper valve plate 202, a sealing disc 204, and a lower valve plate 206. In various aspects, a fitting 208 can extend through the lower valve plate 206 and support a sensor 222 below and spaced from the lower valve plate 206. Upper valve plate 202 can comprise a reduced diameter gap 230 that facilitates moving pressurized water in shoe 108 to lower barrel 106 when the valve assembly 200 moves downward into an open configuration 1100, as shown in the view of FIG. 11.

A lower valve plate nut 210 can couple to a lower stem fitting 212 or stem 212. For example, the lower stem fitting 212 can be coupled to a hollow upper stem or stem body 215 that can be interposed between the valve assembly 200 on the lower end of stem 212 and the operational nut 110 of hydrant assembly 100, as shown in FIG. 1. A cross-section of a float 214 is also shown. Float 214 can also be disposed on an air release valve assembly, referred to herein as air release assembly 220. Air release assembly 200 can be mounted on the lower valve plate 206. Specifically, air release assembly 200 can be mounted on a lower surface of the lower valve plate 206, as discussed below. In various aspects, sealing disc 204 (and the remainder of the valve plate assembly 200, including upper valve plate 202 and lower valve plate 206) can move (e.g., translate) into and away from a seat ring 216 by rotation of operating nut 110 to move the stem 212 downward and thereby to charge the lower barrel 106 and/or hydrant 102. Returning the sealing disc 204 of the valve plate assembly 200 to the closed configuration 250, shown in FIG. 2, closes the valve and allows water within the lower barrel 106 to exit so that the lower barrel 106 can be maintained in a dry state, e.g., over winter months. In the closed configuration, valve assembly 200 can separate a compressible fluid above from an incompressible fluid below the valve plate assembly 200 and specifically across the sealing disc 204. Drain holes 232 can be defined in the lower barrel 106 and/or in the shoe 108 between flanges 120,122 in space 132. Drain holes 232 can allow the lower barrel 106 to drain when the valve plate assembly 200 is closed (e.g., in closed configuration 250), but the drain holes 232 can be covered when the valve plate assembly is open (e.g., in open configuration 1100 shown in FIG. 11).

Operation or rotation of the operating nut 110 (FIG. 1) translates the valve plate assembly 200 downwards along axis 150 within shoe 108. When the operating nut 110 is rotated, the valve plate assembly 200 moves into a water column within the hydrant shoe 108 and the water is free to flow around valve plate assembly 200 and into lower barrel 106 and above into hydrant 102 (FIG. 1). When valve plate assembly 200 is in a closed configuration of FIG. 2, as shown in FIG. 2, in the open and closed configuration, sensor 222 remains within the water column, immersed in the incompressible fluid side of the valve plate assembly 200.

In various aspects, sensor 222 and/or air release assembly 220 can operate to monitor the system and remove accumulated air (or other compressible fluid) from within the system, respectively. In some aspects, the air release assembly 220 can operate to automatically remove air from the water column (or other incompressible fluid) to maintain a water level that keeps the sensor 222 completely submerged. By keeping sensor 222 submerged in or below the water line or incompressible fluid, the air release assembly 220 enhances the accuracy and reliability of the data obtained by sensor 222. For some sensors 222, such as acoustic sensors, hydrophones, pressure and/or temperature sensors, the air trapped above the water line can act as a dampener and may reduce or impede the ability of the sensor to accurately measure the parameter. Air release assembly 220 can automate the process of removing the trapped air to ensure the sensors 222 are submerged and provide accurate measurements of the parameters the sensor 222 was calibrated to detect in a submerged environment.

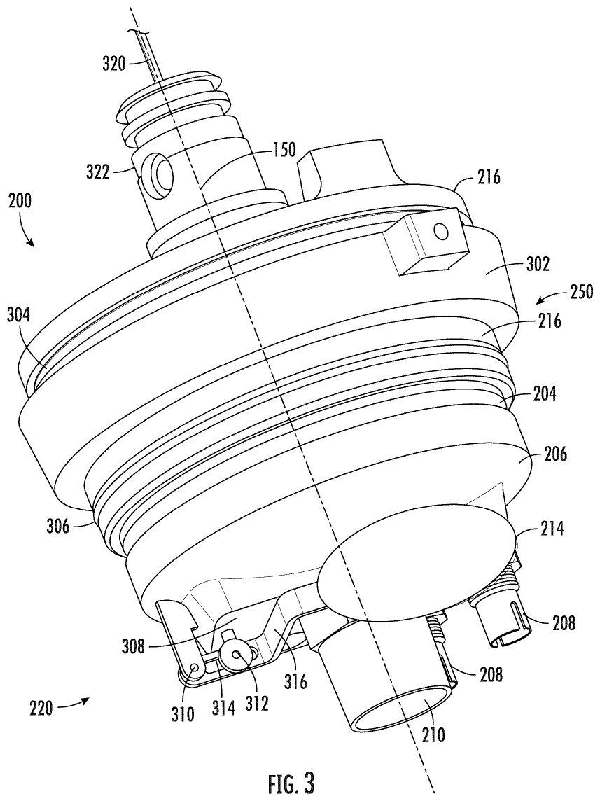

FIG. 3 is a perspective view of the valve plate assembly 200 and the air release assembly 220. Upper valve plate 202 (FIG. 2) is removed from the perspective view shown in FIG. 3, and the sealing disc 204 and lower valve plate 206 are shown coupled to a seat ring 216 and drain ring 302 of the lower barrel 106 and shoe 108 of the hydrant assembly 100, shown in FIG. 1. Upper seat ring seal 304 and lower seat ring seal 306 can facilitate the fluid-tight junction, or seal, between shoe 108 and lower barrel 106 (FIG. 1). In this way, valve plate assembly 200 can ensure a fluid-tight seal between seat ring 216 and sealing disc 204 in the closed configuration 250 of FIGS. 2 and 3.

Lower valve plate 206 can support air release assembly 220 mounted on a lower surface 308 of the lower valve plate 206. Air release assembly 220 can comprise a fixed pivot 310, a translating pivot 312 linearly moveable through a track 314, and extending about a moment arm 316 of air release assembly 220. Float 214 can be coupled to an end of the moment arm 316 opposite the fixed pivot 310. Float 214 can move the moment arm 316, by rotating moment arm 316 about the fixed pivot 310. When the moment arm 316 rotates, the moment arm 316 can translate the translating pivot 312, e.g., axially parallel to axis 150 through the lower surface 308. When water or other incompressible fluid levels in the column or shoe 108 (FIG. 1) lowers away from the lower surface 308 (e.g., compressible fluid, such as air, accumulates), the float 214 can rotate or pivot about the fixed pivot 310 and translate the translating pivot 312 to open a valve of air release assembly 220. In this way, air release assembly 220 can release air from the water column in shoe 108 (FIG. 1). As used herein, air is used as an example of compressible fluid, and water is used as an exemplary incompressible fluid.

As illustrated, fitting 208 can extend through lower valve plate 206 (and/or sealing disc 204) to support and/or secure sensor 222 (FIG. 2). A cable 320 can run through stem 212 (FIG. 2) to send/receive electrical signals to/from one or more sensors 222 installed within fitting 208 of air release assembly 220. Stem 212 can have a head 322 coupled within stem 212 to seal wires extending through stem 212. As described, float 214 can operate to maintain the fluid level above lower ends of the fitting 208 and/or the sensor 222. When the water fluid level drops below the lower surface 308 of the lower valve plate 206, float 214 pulls moment arm 316 downward and translates the translating pivot 312 to move air release assembly 220 and release the air trapped in shoe 108. In this way, the air release assembly 220 can maintain the water level above (e.g., higher than) a lower end of the sensor 222 on fitting 208. This configuration can enhance the accuracy of sensor 222 by maintaining sensor 222 completely submerged in water or other incompressible fluid. In aspects, air release assembly 220 can operate to automatically maintain the incompressible fluid level above float 214 and sensor 222 and between sensor 222/float 214 and the lower surface 308.

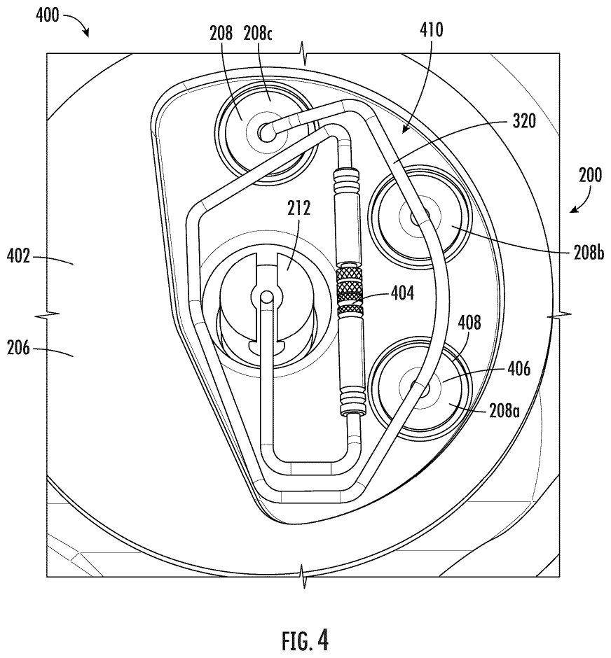

FIG. 4 is a top view of the valve plate assembly 200 with the upper valve plate 202 and sealing disc 204 removed (FIG. 2). FIG. 4 shows a sensor assembly 400 on an upper surface 402 of the lower valve plate 206. In various aspects, the sensor assembly 400 can be housed between the sealing disc 204 (FIG. 2) and the lower valve plate 206. As shown, sensor assembly 400 is housed within the cavity 410 defined by the lower valve plate 206 to capture sensor assembly 400 between lower valve plate 206 and sealing disc 204. Sensor assembly 400 can be housed within valve plate assembly 200 in a way that captures the sensor assembly 400 between the upper valve plate 202, the sealing disc 204, and/or the lower valve plate 206. In this way, the sensor assembly 400 can be completely captured within or housed by the valve plate assembly 200.

Cable 320 extends from the stem 212 to a connector 404 and can be configured to send/receive signals from various fittings 208a, 208b, and/or 208c. In various aspects, cable 320 can comprise a plurality of cables 320 and/or can be configured to send/receive signals from various fittings 208 in numerous contemplated ways. The present example is not limiting, and other configurations with different wiring, wires, and/or cables 320 are contemplated. Fittings 208 can each support a respective sensor 222 mounted below and/or spaced apart from the lower valve plate 206. For example, each fitting 208 in sensor assembly 400 can comprise a head 406 that has a larger diameter than a bore 408 extending through lower valve plate 206 to prevent the fitting 208 from translating through the lower valve plate 206. The head 406 can restrain fitting 208 relative to the bore 408 through the lower valve plate 206 and thereby secure the sensor 222 housed and supported in each fitting 208. In this way, sensor assembly 400 can provide a mechanism to capture cable 320, connector 404, head(s) 406, and/or at least a portion of each fitting 208 within a cavity 410 of valve assembly 200 and restrain and support fitting 208 and/or sensor 222 in bore 408. Cavity 410 can be defined in the top of lower valve plate 206 housing cable 320 and/or fitting 208.

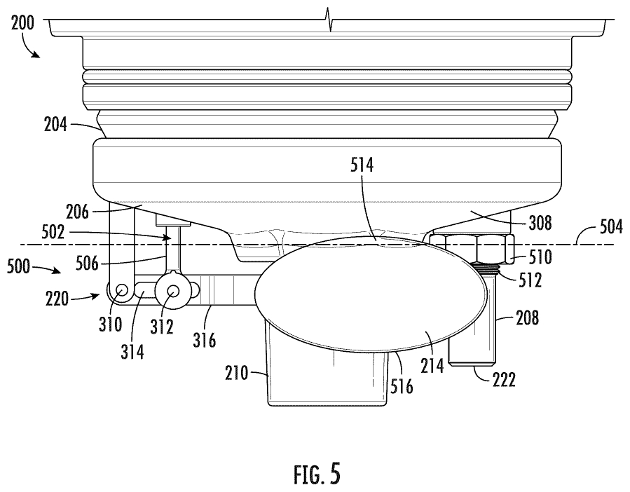

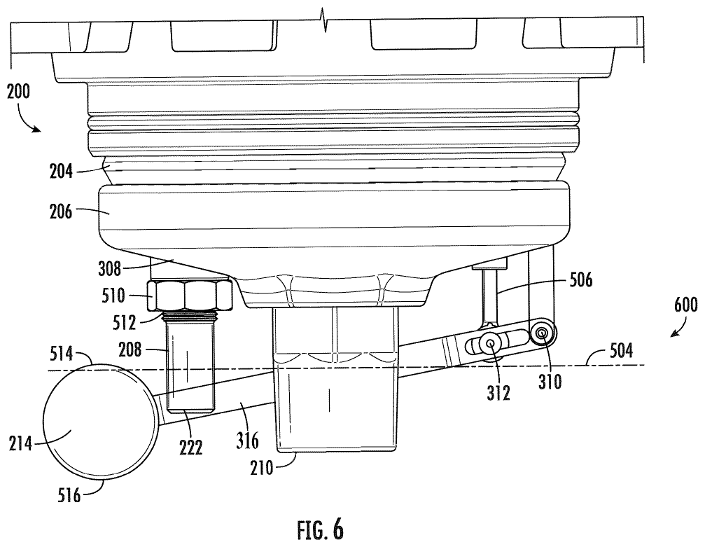

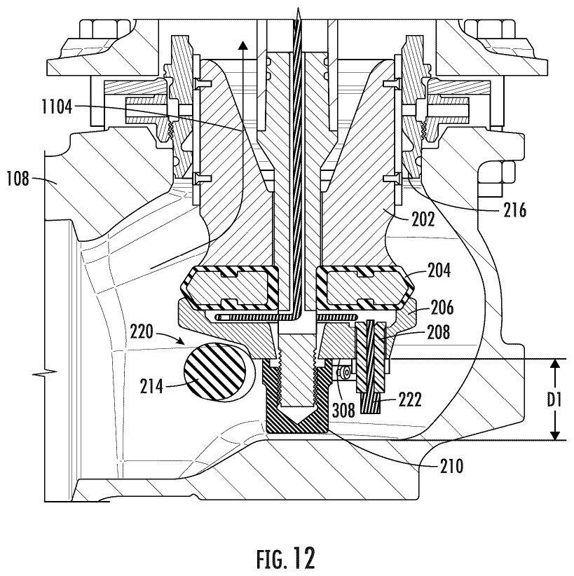

FIG. 5 is an elevated valve plate assembly 200 comprising an air release assembly 220 in a closed position 500, and FIG. 6 is an elevated valve plate assembly 200, shown from the opposite direction, comprising the air release assembly 220 in an open position 600. With reference to FIGS. 5 and 6, air release assembly 220 operates to regulate the compressible fluid (e.g., air) inside a column of incompressible fluid (e.g., water). For example, shoe 108 can capture an incompressible fluid, such as water, that is prevented from flowing through valve plate assembly 200 when valve plate assembly 200 is in the closed position 500. Both FIGS. 5 and 6 show the valve plate assembly 200 in the closed configuration 250 (FIG. 2) to automate a compressible/incompressible fluid boundary 502. Moving the valve plate assembly 200 to an unsealed position is discussed below with reference to FIGS. 11 and 12.

Hydrant assembly 100 can maintain the compressible/incompressible fluid boundary 502 across the valve plate assembly 200 in the closed configuration 250 for extended periods, e.g., between maintenance calls over the course of a year and/or between emergency fire events when hydrant 102 is opened by operating nut 110 (FIG. 1). Unwanted air in hydrant assembly 100 can slowly build up in the system and move the compressible/incompressible fluid boundary 502 downward. The air, or compressible fluid, can become trapped at the top column of shoe 108, e.g., near valve plate assembly 200. Sensors 222 within the water column can be calibrated and/or regulated to provide measurements regarding specific parameters in the water system (e.g., hydrant assembly 100) and can be calibrated to be immersed in the incompressible fluid. For example, sensor 222 can detect the temperature, pressure, velocity, sound, and/or other parameters in the water. Sensors 222 can determine, for example, whether the system is in use, if there is a leak, or if the system is at risk of freezing. Air release assembly 220 can operate to maintain the compressible/incompressible fluid boundary 502 and/or water level or other incompressible fluid level, referred to herein as the fluid surface level 504.

The fluid surface level 504 is defined as the junction between incompressible and compressible fluid. The air release assembly 220 can operate to maintain the fluid surface level 504 above the fitting 208 housing the sensor 222 and below the lower surface 308 of the lower valve plate 206. In this way, the compressible/incompressible fluid boundary 502 can be maintained across valve assembly 200, such that the compressible fluid is released through air release assembly 220, and the incompressible fluid is maintained between the lower surface 308 and the float 214. In aspects, the fluid surface level 504 can be maintained above float 214, fitting 208, and/or sensor 222 to enhance accurate measurements of the fluid parameters (e.g., temperature, pressure, velocity, sound, etc.).

As described, air release assembly 220 can operate by rotating float 214 about fixed pivot 310 to translate a shaft 506 coupled to translating pivot 312 within track 314. When the fluid surface level 504 drops due to an increased presence of compressible fluid (e.g., air) in the column, shaft 506 translates downward from FIG. 5 to FIG. 6. In this downward position, a seal 704 on shaft 506 is opened, and the compressible fluid is allowed to escape around shaft 506. As shown in FIG. 6, the fluid surface level 504 can be maintained to be aligned with the top of float 214, and in this way, the fitting 208 and/or sensor 222 can be maintained in the incompressible fluid and be prevented from dropping below the fluid surface level 504.

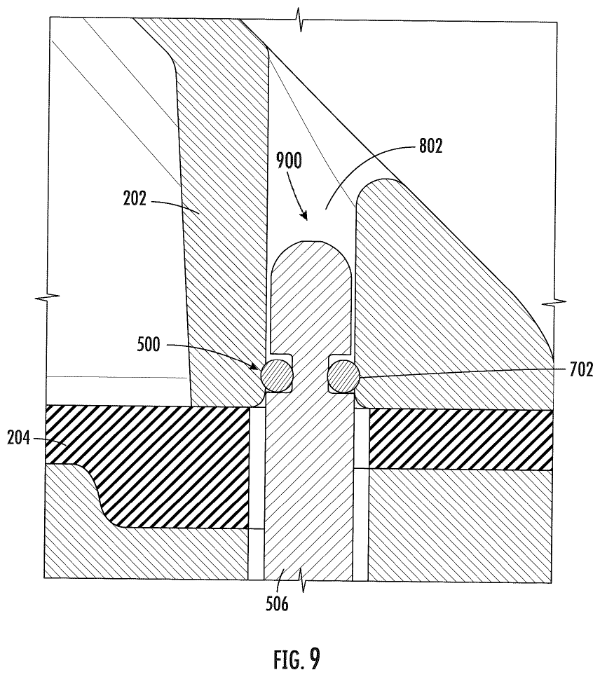

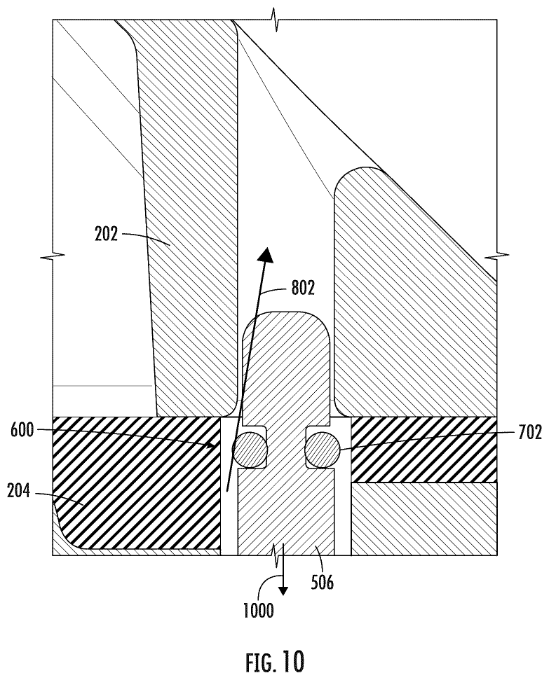

When the sealing disc 204 is in the sealed position 900 (FIG. 9), a bottom side (e.g., lower valve plate 206) of the valve plate assembly 200 can be below the fluid surface level 504 and submerged in the incompressible fluid. In this position, the lower valve plate 206, or the bottom side of the valve plate assembly 200, can be wet, and the upper valve plate 202, or the top side of the valve plate assembly 200, can be dry. When the sealing disc 204 is in the open position 1000 (FIG. 10), both the top and bottom sides (e.g., the upper and lower plates 202, 206) of the valve plate assembly 200 can be wet.

FIGS. 5 and 6 show a nut assembly 510 threadedly engaged with threads 512 on the fitting 208. Nut assembly 510 can be located opposite the heads 406 (FIG. 4) of fitting 208 to capture and secure fitting 208 within valve plate assembly 200. For example, nut assembly 510 and head 406 can capture fitting 208 between upper valve plate 202, sealing disc 204, and/or lower valve plate 206. Float 214 is also illustrated with a top portion 514 and a bottom portion 516, and the fluid surface level 504 can be aligned with either the top portion 514 or the bottom portion 516. In some aspects, fluid surface level 504 is aligned between top portion 514 and bottom portion 516.

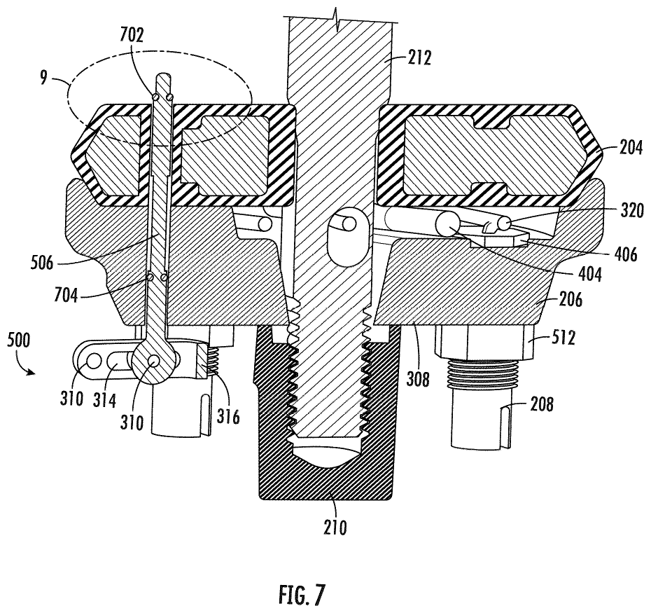

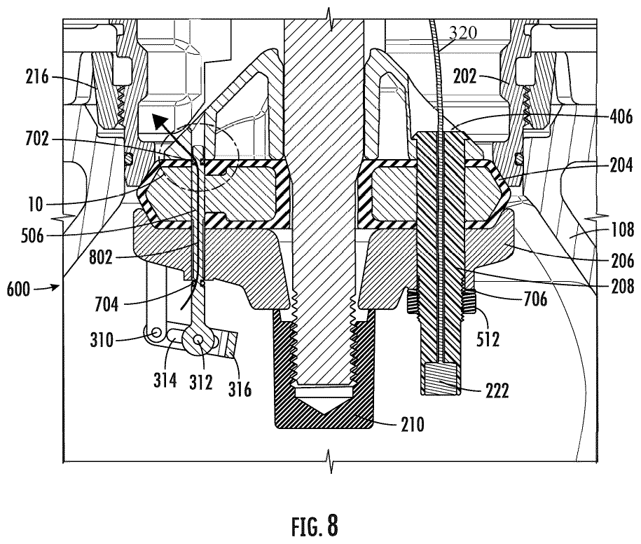

FIGS. 7 and 8 are cross-sectional views of the valve plate assembly 200, showing shaft 506 of the air release assembly 220 moving between the closed position 500 and open position 600, respectively. In some aspects, shown in FIG. 8, cable 320 extends fitting 208 from valve plate assembly 200 off center from stem 212. Similarly, FIGS. 9 and 10 are detailed views 9 and 10 of the closed position 500 and open position 600, respectively, showing a shaft seal 702 translated from a sealed position 900 to an unsealed position 1000. A release path 802 is defined in FIG. 8 in the open position 600. The release path 802 extends through the valve plate assembly 200 (e.g., the upper valve plate 202, sealing disc 204, and/or lower valve plate 206) to permit air or other compressible fluids to escape from one side of sealing disc 204 and maintain the compressible/incompressible fluid boundary 502 across valve assembly 200. In other words, operation of air release assembly 220 can facilitate the automatic release of compressible fluid and/or prevent the escape of water or other compressible fluids to traverse sealing disc 204 to maintain the fluid surface level 504 between the lower surface 308 and the float 214.

FIGS. 9 and 10 show how seals 704 can move from within the shaft seal 702 in the closed position 500 into a larger diameter of the sealing disc 204 to create the release path 802 and release the compressible fluid through the valve plate assembly 200. For example, seals 704 couple to shaft 506 to form the fluid-tight seal in the closed position 500. The seals 704 can be moved to the open position 600 by translating at least one seal 704 on the shaft 506 through the upper valve plate 202 and into a larger diameter hole in the sealing disc 204 of the valve plate assembly 200 to create the release path 802 to permit compressible fluid to escape.

FIGS. 11 and 12 are cross-sectional views taken along lines 2-2 and 7-7 of FIG. 1, showing the valve plate assembly 200 in and open configuration 1100 within the shoe 108 of the hydrant assembly 100. In this open configuration 1100, an incompressible fluid such as water is capable of moving around the valve plate assembly 200 (e.g., including upper valve plate 202, sealing disc 204, and/or lower valve plate 206) to charge the hydrant 102 and/or hydrant assembly 100 shown in FIG. 1.

FIGS. 11 and 12 show that the sensor 222 in fitting 208 and the air release assembly 220 can be configured to fit within a distance D1 measured between the lower surface 308 of lower valve plate 206 and an inner surface 1102 of shoe 108. In this way, the configuration of air release assembly 220 and/or fitting 208 facilitates the automatic escape of compressible fluid in a closed configuration 250 (FIG. 2) and enables the escape of the incompressible fluid across air release assembly 220 in the open configuration 1100, without movement or adjustment to either sensor 222 or air release assembly 220.

Incompressible fluid, such as water, can traverse across the valve plate assembly 200 following incompressible fluid path 1104. As shown, moving the valve plate assembly 200 downward opens up the incompressible fluid path 1104 and in the completely open configuration 1100 of FIGS. 11 and 12, the air release assembly 220 and fitting 208 do not interfere with inner surface 1102 of shoe 108.

The description is provided as an enabling teaching of the present devices, systems, and/or methods in their best, currently known aspect. To this end, those skilled in the relevant art will recognize and appreciate that many changes can be made to the various aspects described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to a quantity of one of a particular element can comprise two or more such elements unless the context indicates otherwise. In addition, any of the elements described herein can be a first such element, a second such element, and so forth (e.g., a first widget and a second widget, even if only a “widget”is referenced).

Ranges can be expressed herein as from “about” one particular value, and/or to “about” another particular value. When such a range is expressed, another aspect comprises from the one particular value and/or to the other particular value. Similarly, when values are expressed as approximations, by use of the antecedent “about” or “substantially,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance may or may not occur, and that the description comprises instances where said event or circumstance occurs and instances where it does not.

The word “or” as used herein means any one member of a particular list and also comprises any combination of members of that list. The phrase “at least one of A and B” as used herein means “only A, only B, or both A and B”; while the phrase “one of A and B” means “A or B.”

As used herein, unless the context clearly dictates otherwise, the term “monolithic” in the description of a component means that the component is formed as a singular component that constitutes a single material without joints or seams.

To simplify the description of various elements disclosed herein, the conventions of “left,” “right,” “front,” “rear,” “top,” “bottom,” “upper,” “lower,” “inside,” “outside,” “inboard,” “outboard,” “horizontal,” and/or “vertical” may be referenced. Unless stated otherwise, “front” describes that end of the seat nearest to and occupied by a user of a seat; “rear” is that end of the seat that is opposite or distal the front; “left” is that which is to the left of or facing left from a person sitting in the seat and facing towards the front; and “right” is that which is to the right of or facing right from that same person while sitting in the seat and facing towards the front. “Horizontal” or “horizontal orientation” describes that which is in a plane extending from left to right and aligned with the horizon. “Vertical” or “vertical orientation” describes that which is in a plane that is angled at 90 degrees to the horizontal.

One should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily comprise logic for deciding, with or without user input or prompting, whether these features, elements and/or steps are included or are to be performed in any particular aspect.

It should be emphasized that the above-described aspects are merely possible examples of implementations, merely set forth for a clear understanding of the principles of the present disclosure. Any process descriptions or blocks in flow diagrams should be understood as representing modules, segments, or portions of code which comprise one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described aspect(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A valve assembly comprising:
a seat ring;
a valve plate assembly moveable between a sealed position wherein the valve plate assembly is sealed against the seat ring, and an open position wherein the valve plate assembly is moved away from the seat ring;
a fitting extending through the valve plate assembly; and
a sensor assembly extending through the fitting, a sensor of the sensor assembly mounted in the fitting below the valve plate assembly.

2. The valve assembly of claim 1, wherein the valve plate assembly comprises:
a lower valve plate, the sensor assembly extending through the lower valve plate, and the sensor mounted below the lower valve plate;
a sealing disc mounted above the lower valve plate;
an upper valve plate mounted above the sealing disc; and
a central axis extending through the lower valve plate, the sealing disc, and the upper valve plate, wherein:
the sensor assembly is located off-center from the central axis and comprises a cable extending through the lower valve plate and at least partially through the sealing disc.

3. The valve assembly of claim 1, further comprising a cable and a stem assembly comprising a stem body and a lower stem fitting, wherein the sensor is electronically coupled to the cable routed through the lower stem fitting attached to the valve plate assembly, and the stem assembly is configured to move the cable with the valve plate assembly between the sealed position and the open position.

4. The valve assembly of claim 1, further comprising a shoe comprising the seat ring and wherein the valve plate assembly comprises a sealing disc, wherein when the sealing disc is in the sealed position, a bottom side of the valve plate assembly is wet, and a top side of the valve plate assembly is dry, and in the open position both the top side and the bottom side of the valve plate assembly are wet.

5. The valve assembly of claim 1, wherein the fitting is a first fitting and the sensor is a first sensor, and wherein the valve assembly further comprises a second sensor mounted in a second fitting, and a third sensor mounted in a third fitting.

6. The valve assembly of claim 5, wherein the valve plate assembly comprises a lower valve plate and a sealing disc, and wherein the first sensor is electrically coupled to a first sensor cable, the second sensor is electrically coupled to a second sensor cable, and the third sensor is electrically coupled to a third sensor cable, and wherein each cable is captured within the valve plate assembly between the lower valve plate and the sealing disc.

7. The valve assembly of claim 5, wherein the first sensor, the second sensor, and the third sensor are each selected from a group comprising a hydrophone, an acoustic sensor, a pressure sensor, and a temperature sensor.

8. The valve assembly of claim 5, wherein the valve plate assembly defines a central axis and the first sensor, the second sensor, and the third sensor extend off-center through the valve plate assembly in a circular pattern that surrounds the central axis.

9. The valve assembly of claim 1, wherein the valve plate assembly comprises a lower valve plate and the fitting comprises a head on a top end and a nut assembly on a bottom end, wherein the fitting extends through the lower valve plate and the head is on an upper side of the lower valve plate and the nut assembly is coupled to a lower side of the lower valve plate, the fitting extending through the lower valve plate.

10. The valve assembly of claim 9, wherein:
the head is larger than a bore extending through the lower valve plate and the head couples to the upper side of the lower valve plate; and
the nut assembly comprises a nut threadedly engaged to the fitting, the nut capturing the fitting in the lower valve plate and sealing the fitting in the lower valve plate.

11. A valve assembly comprising:
a seat ring;
a valve plate assembly configured to seal against the seat ring in a sealed position, the valve plate assembly comprising a sealing disc and a lower valve plate; and
an air release valve extending through the lower valve plate of the valve plate assembly.

12. The valve assembly of claim 11, wherein the sealing disc comprises metal captured in rubber, the lower valve plate comprises metal, and the sealing disc covers a top portion of the lower valve plate, and wherein the sealing disc is captured between the seat ring and the lower valve plate in the sealed position.

13. The valve assembly of claim 11, wherein the valve plate assembly is configured to selectively move between the sealed position and an open position, and wherein in the open position, the valve plate assembly is moved away from the seat ring.

14. The valve assembly of claim 13, wherein the air release valve comprises a float, a lever arm, a pivot, and a seal, and wherein the float is configured to selectively move the lever arm about the pivot to translate the seal between a closed position and the open position.

15. The valve assembly of claim 11, wherein the air release valve comprises a float comprising a top side and a bottom side, wherein the bottom side of the float is configured to be submerged in incompressible fluid, and the top side of the float is configured to align at or above a fluid surface level.

16. The valve assembly of claim 15, further comprising a fitting extending through the valve plate assembly and a sensor mounted on the fitting; wherein the air release valve is captured within a fluid column and defines a release path through the valve plate assembly, and wherein the air release valve automatically removes air from one side of the valve plate assembly through the release path when the fluid surface level is between the sensor and the lower valve plate.

17. The valve assembly of claim 11, wherein the air release valve comprises a shaft comprising an upper seal and a lower seal and the shaft extends through the valve plate assembly to define a release path, wherein in an open position, the shaft is translated, and air can escape through the release path around the upper seal and the lower seal.

18. The valve assembly of claim 17, wherein the sealing disc comprises a bore defining an inner surface of the release path and extending through the sealing disc, and wherein the inner surface is covered in rubber.

19. A method comprising:
installing a fitting through a lower valve plate of a valve plate assembly and mounting a sensor in the fitting below the lower valve plate;
installing an air release valve in the valve plate assembly;
installing the valve plate assembly in a column of fluid defining a fluid surface level; and
moving the air release valve from a closed position to an open position to remove air in the column of fluid so that the sensor remains below the fluid surface level.

20. The method of claim 19, wherein the fitting is a first fitting, and the sensor is a first sensor, and the method further comprises installing a second fitting through the valve plate assembly to mount a second sensor in the column of fluid.

21. The method of claim 19, wherein the sensor and the air release valve are installed off center from a central axis of the valve plate assembly.

22. The method of claim 19, further comprising forming the valve plate assembly by installing an upper valve plate on a first side of the valve plate assembly and the lower valve plate on a second side of the valve plate assembly opposite the first side to form the valve plate assembly, and further comprising electronically coupling the sensor to a cable, and positioning the cable in the valve plate assembly between the upper valve plate and the lower valve plate.

23. The method of claim 19, wherein installing the valve plate assembly in the column of fluid comprises installing the valve plate assembly within a shoe of a fire hydrant assembly.

24. The method of claim 19, wherein the valve plate assembly comprises a sealing disc and the air release valve comprises a shaft and a bore extending through the sealing disc, and wherein moving the air release valve from the closed position to the open position moves the shaft through the bore of the sealing disc to create a release path about the shaft and through the bore.
